(19) United States
(12) Patent Application Publication
(10) Pub. No.: US 2023/0133650 A1
(43) Pub. Date: May 4, 2023

(54) CHEMICALLY STRENGTHENED OPTICAL GLASS

(71) Applicant: OHARA INC., KANAGAWA (JP)

(72) Inventor: SAYA KIKKAWA, KANAGAWA (JP)

(21) Appl. No.: 17/913,440

(22) PCT Filed: Mar. 15, 2021
(86) PCT No.: PCT/JP2021/010265

§ 371 Date: Sep. 22, 2022

(30) Foreign Application Priority Data
Mar. 24, 2020 (JP) 2020-052577
Apr. 24, 2020 (JP) 2020-077384

(51) Int. Cl. C03C 3/062

(52) U.S. Cl. CPC C03C 3/062; C03C 21/002

(57) ABSTRACT

Provided is a chemically strengthened optical glass with improved crack resistance and high hardness, in which the refractive index, the Abbe number, and the transmittance required for a conventional optical glass are maintained.

The chemically strengthened optical glass includes a compressive stress layer on a surface, and contains, by mass % in terms of oxide: 20.0% to 50.0% of a SiO₂ component, 10.0% to 45.0% of a TiO₂ component, and 0.1 to 20.0% of a Na₂O component, and the chemically strengthened optical glass is characterized in that an Hv change rate defined as [(Hv_{after}−Hv_{before})/Hv_{before}]×100 is equal to or greater than 3.0%.

### FIELD OF THE DISCLOSURE

The present disclosure relates to a chemically strengthened optical glass having a compressive stress layer on a surface.

### BACKGROUND OF THE DISCLOSURE

In recent years, there has been a focus on wearable terminals utilized for artificial reality (AR) and virtual reality (VR), such as eyeglasses having a projector, eyeglass-type displays, goggle-type displays, artificial reality display devices, augmented reality display devices, and virtual image display devices, as well as onboard cameras and the like.

Such wearable terminals and onboard cameras are expected to be used in harsh external environments. Therefore, there is a demand for an optical glass having high hardness and improved impact resistance, wind pressure resistance, scratch resistance, and the like (hereinafter referred to as “crack resistance”), while maintaining a high refractive index, Abbe number, and transmittance required for conventional optical glass. There is also a demand for miniaturization.

Regarding the issues of digitization and definition enhancement of optical equipment, Patent Document 1 discloses a glass having a high refractive index and high dispersion with a refractive index (nd) of 1.7 or more and an Abbe number (νd) of 20 or more and 30 or less. However, such a glass is not expected to be used in a harsh external environment, and does not also disclose an optical glass having high hardness and focusing on crack resistance. In addition, at the time of filing of Patent Document 1, modern state-of-the-art technologies such as VR and AR were not widespread. Moreover, in recent years, another application that has rapidly increased in popularity are onboard cameras, which play a key role in autonomous driving and as “sensors for perimeter recognition” in vehicles to ensure safety. Therefore, an optical glass with improved crack resistance and high hardness was not envisioned at the time of filing of Patent Document 1.

If the optical glass has high strength, it is possible to use a thinner glass for an optical lens, so that the optical lens can be made thinner and smaller.

### PRIOR ART DOCUMENT

### [Patent Document]

[Patent Document 1] Japanese Unexamined Patent Application Publication No. 2009-203134

### SUMMARY OF THE DISCLOSURE

Accordingly, an object of the present disclosure is to obtain an optical glass with improved crack resistance and high hardness, while maintaining the refractive index, Abbe number, and transmittance required for a conventional optical glass.

In order to solve the above-mentioned problems, the present inventors have conducted intensive experiments and research, and as a result, have developed a glass composition and combination suitable for obtaining a high-hardness optical glass having a high Vickers hardness (Hv) and including a compressive stress layer on a surface formed by chemically strengthening an optical glass, which led to the completion of the present disclosure.

Specifically, the present disclosure provides the following configurations.

(1) A chemically strengthened optical glass including a compressive stress layer on a surface,

the chemically strengthened optical glass containing, by mass % in terms of oxide:

20.0% to 50.0% of a SiO₂ component,

10.0% to 45.0% of a TiO₂ component, and

0.1 to 20.0% of a Na₂O component,

an Hv change rate defined as [(Hv_{after}−Hv_{before})/Hv_{before}]×100 is equal to or greater than 3.0%.

(2)

The chemically strengthened optical glass according to (1), further containing 3.0 to 20.0% of a Nb₂O₅ component by mass % in terms of oxide.

(3)

The chemically strengthened optical glass according to (1) or (2), further containing, by mass % in terms of oxide:

0 to 15.0% of Al₂O₃,

0 to 15.0% of ZrO₂,

0 to 20.0% of BaO,

0 to 10.0% of Li₂O,

0 to 15.0% of K₂O, and

0 to 1.0% of Sb₂O₃.

(4)

The chemically strengthened optical glass according to any one of (1) to (3), in which a refractive index (nd) is from 1.65 to 1.85 and an Abbe number (νd) is from 20.0 to 33.0.

According to the present disclosure, it is possible to provide a chemically strengthened optical glass including a compressive stress layer and having improved crack resistance and high hardness, while maintaining a high refractive index, Abbe number, and transmittance.

### DETAILED DESCRIPTION OF THE EXEMPLARY EMBODIMENTS

A composition range of each component included in a chemically strengthened optical glass of the present disclosure is described below. As used herein, all the contents of each component are expressed by mass % with respect to the total mass of an oxide-equivalent composition, unless otherwise specified. Here, the “oxide-equivalent composition” refers to a composition expressing all components contained in a glass, when assuming that all oxides, composite salts, metal fluorides, and the like used as raw materials for the constituent components of the glass of the present disclosure are decomposed and transformed into oxides during melting, and the total mass number of the produced oxides is 100 mass %.

[Glass Components]

The chemically strengthened optical glass of the present disclosure includes a compressive stress layer on a surface, and contains, by mass % in terms of oxide: 20.0% to 50.0% of a SiO₂ component, 10.0% to 45.0% of a TiO₂ component, and 0.1 to 20.0% of a Na₂O component, and the chemically strengthened optical glass is characterized in that an Hv change rate defined as [(Hv_{after}−Hv_{before})/Hv_{before}]×100 is equal to or greater than 3.0%.

[Essential Components and Optional Components]

The SiO₂ component is a component forming a network structure of the glass, is a component that reduces devitrification (generation of crystals), which is undesirable in an optical glass, and is an essential component of the chemically strengthened optical glass of the present disclosure.

In particular, if the content of the SiO₂ component is set to 20.0% or more, a stable optical glass can be produced. Therefore, a lower limit of the content of the SiO₂ component is preferably 20.0% or more, more preferably 23.0% or more, and still more preferably more than 25.0%.

If the content of the SiO₂ component is set to 50.0% or less, it is possible to suppress an excessive increase in viscosity, a deterioration of the meltability, and a decrease of the refractive index. Moreover, a deterioration of the chemical strengthening can be suppressed. Thus, an upper limit of the content of the SiO₂ component is preferably 50.0% or less, more preferably 47.0% or less, and still more preferably 43.0% or less.

The TiO₂ component is a component that increases the refractive index and the chemical durability (acid resistance), and is an essential component of the chemically strengthened optical glass of the present disclosure.

In particular, if the content of the TiO₂ component is set to 10.0% or more, a desired refractive index, Abbe number, and the like of the glass may be achieved. Therefore, a lower limit of the content of the TiO₂ component is preferably 10.0% or more, more preferably 13.0% or more, and still more preferably more than 15.0%.

If the content of the TiO₂ component is set to 45.0% or less, it is possible to suppress a decrease in the transmittance of the glass with respect to visible light (in particular, light having a wavelength of 500 nm or less). Thus, an upper limit of the content of the TiO₂ component is preferably 45.0% or less, more preferably 40.0% or less, still more preferably 35.0% or less, and even more preferably 33.0% or less.

The Na₂O component is a component that improves the meltability of the glass, is a component utilized for an ion exchange in chemical strengthening, as described later, and is an essential component in the chemically strengthened optical glass of the present disclosure.

In particular, if the content of the Na₂O component is set to 0.1% or more, an exchange reaction proceeds between a potassium component (potassium ions) having a large ionic radius in a molten salt and a sodium component (sodium ions) having a small ionic radius in a substrate, and as a result, compressive stress is produced on a surface of the substrate. Therefore, a lower limit of the content of the Na₂O component is preferably 0.1% or more, more preferably 0.5% or more, and still more preferably 5.0% or more.

On the other hand, if the content of the Na₂O component is 20.0% or less, the refractive index of the glass is unlikely to decrease and the devitrification of the glass can be reduced. Therefore, an upper limit of the content of the Na₂O component is preferably 20.0% or less, more preferably 17.0% or less, still more preferably 15.0% or less, and even more preferably less than 14.0%.

A Nb₂O₅ component is a component that increases the refractive index and stabilizes the glass, and is an optional component of the chemically strengthened optical glass of the present disclosure.

In particular, if the content of the Nb₂O₅ component is set to 3.0% or more, the devitrification resistance can be increased. In addition, it is possible to suppress a decrease in hardness by a salt bath during chemical strengthening. Therefore, a lower limit of the content of the Nb₂O₅ component is preferably 3.0% or more, more preferably 4.0% or more, still more preferably more than 5.0%, and even more preferably 6.0% or more.

If the content of the Nb₂O₅ component is 20.0% or less, devitrification due to an excessive content of the Nb₂O₅ component can be reduced. Therefore, an upper limit of the content of the Nb₂O₅ component is preferably 20.0% or less, more preferably 17.0% or less, still more preferably 15.0% or less, and even more preferably 13.0% or less.

If the content of a K₂O component is more than 0%, the K₂O component adjusts the refractive index and the Abbe number while adjusting the meltability of the glass. The K₂O component is a component that can improve the compressive stress on the surface of the glass in the chemical strengthening. Therefore, a lower limit of the content of the K₂O component is preferably more than 0%, more preferably 0.5% or more, and still more preferably 2.0% or more.

If the content of the K₂O component is 15.0% or less, the refractive index of the glass is unlikely to decrease and the devitrification of the glass can be reduced. Therefore, an upper limit of the content of the K₂O component is preferably 15.0% or less, more preferably 10.0% or less, still more preferably 8.0% or less, and even more preferably 7.5% or less.

If the content of a Li₂O component is more than 0%, the Li₂O component adjusts the refractive index and the Abbe number while adjusting the meltability of the glass. The Li₂O component is a component to be utilized in an ion exchange in the chemical strengthening.

If the content of the Li₂O component is set to 10.0% or less, it is possible to suppress a decrease of the refractive index and reduce the devitrification due to an excessive content of the Li₂O component. Thus, an upper limit of the content of the Li₂O component is preferably 10.0% or less, more preferably 8.0% or less, and still more preferably 7.5% or less.

If the content of a BaO component is more than 0%, the BaO component increases the refractive index of the glass. The BaO component is an optional component in the chemically strengthened optical glass of the present disclosure. If the content of the BaO component is more than 0%, it is also possible to suppress a decrease in hardness by a salt bath during chemical strengthening. Therefore, a lower limit of the content of the BaO component is preferably more than 0%, more preferably 1.0% or more, and still more preferably 2.0% or more.

On the other hand, if the content of the BaO component is 20.0% or less, it is possible to prevent a deterioration of devitrification properties. Thus, an upper limit of the content of the BaO component is preferably 20.0% or less, more preferably 15.0% or less, and still more preferably 12.0% or less.

If the content of a MgO component, a CaO component, and a SrO component is more than 0%, these components increase the refractive index of the glass. These components are optional components in the chemically strengthened optical glass of the present disclosure.

On the other hand, if the content of the MgO component, the CaO component, and the SrO component is 20.0% or less, it is possible to suppress a decrease in hardness by a salt bath during chemical strengthening. Thus, an upper limit of the content of the MgO component, the CaO component, and the SrO component is preferably 20.0% or less, more preferably 15.0% or less, and still more preferably 10.0% or less.

In particular, from the viewpoint of productivity, the CaO component is preferably less than 0.5%, and more preferably less than 0.3%, to reduce the deterioration of the devitrification properties.

If the content of a ZnO component is more than 0%, the ZnO component increases the refractive index of the glass. The ZnO component is an optional component in the chemically strengthened optical glass of the present disclosure.

On the other hand, if the content of the ZnO component is 15.0% or less, it is possible to suppress a decrease in hardness by a salt bath during chemical strengthening. Thus, an upper limit of the content of the ZnO component is preferably 15.0% or less, more preferably 10.0% or less, and still more preferably 8.0% or less.

If the content of an Al₂O₃ component is more than 0%, the Al₂O₃ component is an effective component for increasing the chemical durability of the glass and improving the devitrification resistance of a molten glass. The Al₂O₃ component is an optional component in the chemically strengthened optical glass of the present disclosure.

On the other hand, if the content of the Al₂O₃ component is 15.0% or less, it is possible to lower the liquidus temperature of the glass, and reduce the devitrification due to an excessive content of the Al₂O₃ component. Thus, an upper limit of the content of the Al₂O₃ component is preferably 15.0% or less, more preferably 10.0% or less, and still more preferably 5.0% or less.

If the content of a ZrO₂ component is more than 0%, the ZrO₂ component increases the refractive index of the glass. The ZrO₂ component is an optional component in the chemically strengthened optical glass of the present disclosure.

On the other hand, if the content of the ZrO₂ component is 15.0% or less, it is possible to reduce the devitrification due to an excessive content of the ZrO₂ component. Thus, an upper limit of the content of the ZrO₂ component is preferably 15.0% or less, more preferably 10.0% or less, and still more preferably 5.0% or less.

A B₂O₃ component is an optional component that can promote stable glass formation and increase the devitrification resistance, if the content of the B₂O₃ component is more than 0%.

On the other hand, if the content of the B₂O₃ component is 15.0% or less, devitrification due to an excessive content of the B₂O₃ component can be reduced. Thus, an upper limit of the content of the B₂O₃ component is preferably 15.0% or less, more preferably 10.0% or less, and still more preferably 5.0% or less.

A La₂O₃ component, a Gd₂O₃ component, a Y₂O₃ component, and a Yb₂O₃ component are optional components that can increase the refractive index and reduce the partial dispersion ratio, if the content of at least any one of the La₂O₃ component, the Gd₂O₃ component, the Y₂O₃ component, and the Yb₂O₃ component is more than 0%.

On the other hand, if the La₂O₃ component, the Gd₂O₃ component, the Y₂O₃ component, and the Yb₂O₃ component are contained in a large amount, the liquidus temperature is lowered and the glass is devitrified.

In particular, if each of the contents of the La₂O₃ component, the Gd₂O₃ component, the Y₂O₃ component, and the Yb₂O₃ component is set to 10.0% or less, it is possible to reduce devitrification and coloring of the glass. Therefore, an upper limit of each of the contents of the La₂O₃ component, the Gd₂O₃ component, the Y₂O₃ component, and the Yb₂O₃ component is preferably 10.0% or less, more preferably 8.0% or less, still more preferably 5.0% or less, and most preferably 3.0% or less.

A WO₃ component is an optional component that can increase the refractive index, decrease the Abbe number, and enhance the meltability of the glass raw material.

On the other hand, if the content of the WO₃ component is set to 10.0% or less, it is possible to prevent an increase of the partial dispersion ratio of the glass and reduce the coloring of the glass to increase the internal transmittance. Therefore, an upper limit of the content of the WO₃ component is preferably 10.0% or less, more preferably 5.0% or less, still more preferably 3.0% or less, and most preferably 1.0% or less.

A P₂O₅ component is an optional component that can improve the stability of the glass.

On the other hand, if the content of the P₂O₅ component is 5.0% or less, an increase of the partial dispersion ratio due to an excessive content of the P₂O₅ component can be reduced. Thus, an upper limit of the content of the P₂O₅ component is preferably 5.0% or less, more preferably 3.0% or less, and still more preferably 1.0% or less.

A Ta₂O₅ component is an optional component that can increase the refractive index, decrease the Abbe number and the partial dispersion ratio, and increase the devitrification resistance.

In particular, if the content of the Ta₂O₅ component is set to 10.0% or less, the usage amount of the Ta₂O₅ component, which is a rare mineral resource, is reduced, and the glass melts more easily at a lower temperature. Thus, the production cost of the glass can be reduced. In addition, it is possible to reduce devitrification of the glass due to an excessive content of the Ta₂O₅ component. Thus, an upper limit of the content of the Ta₂O₅ component is preferably 10.0% or less, more preferably 5.0% or less, still more preferably 3.0% or less, and even more preferably 1.0% or less. In particular, from the viewpoint of reducing the material cost of the glass, the Ta₂O₅ component may not be contained.

A GeO₂ component is an optional component that can increase the refractive index and reduce devitrification. If the content of the GeO₂ component is set to 10.0% or less, the usage amount of the expensive GeO₂ component is reduced, and thus it is possible to reduce the material cost of the glass. Thus, an upper limit of the content of the GeO₂ component is preferably 10.0% or less, more preferably 5.0% or less, still more preferably 3.0% or less, and even more preferably 1.0% or less.

A Ga₂O₃ component is an optional component that can increase the refractive index and improve the devitrification resistance.

If the content of the Ga₂O₃ component is set to 10.0% or less, devitrification due to an excessive content of the Ga₂O₃ component can be reduced. Thus, an upper limit of the content of the Ga₂O₃ component is preferably 10.0% or less, more preferably 5.0% or less, still more preferably 3.0% or less, and even more preferably 1.0% or less.

A Bi₂O₃ component is an optional component that can increase the refractive index, decrease the Abbe number, and lower the glass transition temperature. If the content of the Bi₂O₃ component is set to 10.0% or less, it is possible to prevent an increase of the partial dispersion ratio and reduce the coloring of the glass to increase the internal transmittance. Therefore, an upper limit of the content of the Bi₂O₃ component is preferably 10.0% or less, more preferably 5.0% or less, still more preferably 3.0% or less, and even more preferably 1.0% or less.

A TeO₂ component is an optional component that can increase the refractive index, lower the partial dispersion ratio, and lower the glass transition temperature. If the content of the TeO₂ component is set to 10.0% or less, it is possible to reduce the coloring of the glass to increase the internal transmittance. If the use of the expensive TeO₂ component is reduced, it is possible to obtain a glass with a lower material cost. Therefore, an upper limit of the content of the TeO₂ component is preferably 10.0% or less, more preferably 5.0% or less, still more preferably 3.0% or less, and even more preferably 1.0% or less. In particular, from the viewpoint of reducing the material cost of the glass, the TeO₂ component may not be contained.

An SnO₂ is an optional component capable of clarifying (degassing) a molten glass and increasing the transmittance of the glass for visible light. If the SnO₂ content is set to 1.0% or less, it is possible to prevent coloring of the glass due to a reduction reaction in the molten glass, and devitrification of the glass. In addition, it is possible to suppress the formation of alloys between SnO₂ and equipment (in particular, equipment made of precious metals such as Pt) for the melting process, and thus the life span of the equipment for the melting process can be increased. Thus, an upper limit of the SnO₂ content is preferably 1.0% or less, more preferably 0.5% or less, and still more preferably 0.1% or less.

An Sb₂O₃ component is an optional component capable of degassing the molten glass, if the content of the Sb₂O₃ component is more than 0%.

On the other hand, if the content of the Sb₂O₃ component is set to 1.0% or less, it is possible to suppress a decrease of the transmittance in a short wavelength region of the visible light region, solarization of the glass, and a deterioration of internal quality. Therefore, the content of the Sb₂O₃ component may be preferably 1.0% or less, more preferably less than 0.7%, still more preferably 0.5% or less, and most preferably 0.4% or less.

If the sum of the contents (mass sum) of Rn₂O components (Rn being one or more types selected from the group consisting of Li, Na, and K) is 5.0% or more, it is possible to improve the meltability of the glass. Therefore, a lower limit of the sum of the Rn₂O components is preferably 5.0% or more, more preferably 7.0% or more, and still more preferably 10.0% or more.

If the sum of the contents (mass sum) of the Rn₂O components is set to 30.0% or less, it is possible to suppress a decrease of the refractive index and reduce the devitrification due to an excessive content of the Rn₂O components. Therefore, an upper limit of the sum of the contents of the Rn₂O components is preferably 30.0% or less, more preferably 25.0% or less, still more preferably 23.0% or less, and most preferably 20.0% or less.

If the sum of the contents of RO components (R being one or more types selected from the group consisting of Mg, Ca, Sr, and Ba) is more than 0%, it is possible to improve the meltability at low temperatures. Therefore, a lower limit of the sum of the contents of the RO components is preferably more than 0%, more preferably 1.0% or more, and still more preferably 2.0% or more.

On the other hand, the sum of the contents of the RO components is preferably 20.0% or less, in order to suppress deterioration of the devitrification resistance due to an excessive content of the RO components. Therefore, an upper limit of the mass sum of the RO components is preferably 20.0% or less, more preferably 15.0% or less, still more preferably 14.0% or less, and even more preferably 13.0% or less.

If the sum of the contents (mass sum) of Ln₂O₃ components (Ln being one or more types selected from the group consisting of La, Y, Gd, and Yb) is more than 0%, it is possible to more easily obtain a high refractive index.

On the other hand, if the sum of the contents (mass sum) of the Ln₂O₃ components is set to 15.0% or less, it is possible to reduce devitrification due to an excessive content of the Ln₂O₃ components. Thus, an upper limit of the sum of the contents of the Ln₂O₃ components is preferably 15.0% or less, more preferably 10.0% or less, and still more preferably 5.0% or less.

If the mass sum of TiO₂+BaO+Nb₂O₅ is set to 30.0% or more, it is possible to increase the refractive index. Therefore, a lower limit of the mass sum of TiO₂+BaO+Nb₂O₅ is preferably 30.0% or more, more preferably 33.0% or more, and still more preferably 35.0% or more.

On the other hand, if the mass sum of TiO₂+BaO+Nb₂O₅ is set to 60.0% or less, it is possible to suppress a decrease of the transmittance of the glass with respect to visible light (in particular, light having a wavelength of 500 nm or less). Therefore, the upper limit of the mass sum of TiO₂+BaO+Nb₂O₅ is preferably 60.0% or less, more preferably 57.0% or less, still more preferably 55.0% or less, and most preferably less than 50.0%.

If the mass ratio K₂O/Na₂O is greater than 0, chemical strengthening can proceed more easily. Therefore, a lower limit of the mass ratio K₂O/Na₂O is preferably greater than 0, more preferably 0.10 or more, and still more preferably 0.20 or more.

On the other hand, if the mass ratio K₂O/Na₂O is set to 1.00 or less, devitrification of the glass can be reduced. Therefore, an upper limit of the mass ratio K₂O/Na₂O is preferably 1.00 or less, more preferably 0.95 or less, and still more preferably 0.90 or less.

If the mass sum of Nb₂O₅+BaO is 9.0% or more, it is possible to suppress a decrease in hardness by a salt bath during chemical strengthening. Therefore, a lower limit of the mass sum of Nb₂O₅+BaO is preferably 9.0% or more, more preferably more than 10.0%, still more preferably 13.0% or more, and even more preferably 15.0% or more.

On the other hand, if the mass sum of Nb₂O₅+BaO is set to 30.0% or less, a deterioration of the devitrification properties of the glass can be reduced. Thus, an upper limit of the mass sum of Nb₂O₅+BaO is preferably 30.0% or less, more preferably 27.0% or less, and still more preferably 25.0% or less.

If the mass sum of SiO₂+RO is set to 35.0% or more, a stable optical glass can be manufactured. Therefore, a lower limit of the mass sum of SiO₂+RO is preferably 35.0% or more, more preferably 38.0% or more, and still more preferably 40.0% or more.

On the other hand, if the mass sum of SiO₂+RO is set to 60.0% or less, it is possible to suppress a decrease in the refractive index and trigger chemical strengthening more easily. Thus, an upper limit of the mass sum of SiO₂+RO is preferably 60.0% or less, more preferably 57.0% or less, and even more preferably 54.0% or less.

If the mass sum of SiO₂+TiO₂+Na₂O is 50.0% or more, it is possible to stably manufacture glass that has a high refractive index and can be chemically strengthened. Therefore, a lower limit of the mass sum of SiO₂+TiO₂+Na₂O is preferably 50.0% or more, more preferably 55.0% or more, still more preferably 60.0% or more, and even more preferably 63.5% or more.

On the other hand, if the mass sum of SiO₂+TiO₂+Na₂O is set to 90.0% or less, it is possible to reduce the deterioration of the devitrification properties of the glass. Thus, an upper limit of the mass sum of SiO₂+TiO₂+Na₂O is preferably 90.0% or less, more preferably 85.0% or less, and even more preferably 81.0% or less.

If the mass sum of SiO₂+Na₂O+BaO is set to 45.0% or more, it is possible to stably manufacture optical glass that can be chemically strengthened. Therefore, a lower limit of the mass sum of SiO₂+Na₂O+BaO is preferably 45.0% or more, more preferably 48.0% or more, still more preferably 50.0% or more, and even more preferably 51.5% or more.

On the other hand, if the mass sum of SiO₂+Na₂O+BaO is set to 70.0% or less, it is possible to suppress a decrease of the refractive index. Thus, an upper limit of the mass sum of SiO₂+Na₂O+BaO is preferably 70.0% or less, more preferably 68.0% or less, and still more preferably 65.0% or less.

If the mass ratio (ZrO₂+Na₂O)/BaO is set to 0.20 or more, a glass material having good devitrification properties and improved meltability is obtained. Therefore, a lower limit of the mass ratio (ZrO₂+Na₂O)/BaO is preferably 0.20 or more, more preferably 0.50 or more, still more preferably 0.60 or more, and even more preferably 0.80 or more.

On the other hand, if the mass ratio (ZrO₂+Na₂O)/BaO is set to 20.0 or less, it is possible to prevent a deterioration of the devitrification properties due to an excessive addition of the components. Thus, an upper limit of the mass ratio (ZrO₂+Na₂O)/BaO is preferably 20.0 or less, more preferably 18.0 or less, still more preferably 15.0 or less, and even more preferably 13.0 or less.

In particular, from the viewpoint of chemical strengthening, it is desirable that the mass ratio (ZrO₂+Na₂O)/BaO is more than 0.86 to facilitate an increase of the hardness by the chemical strengthening.

If the mass sum of SiO₂+Na₂O is 33.0% or more, it is possible to stably manufacture optical glass that can be chemically strengthened.

Therefore, a lower limit of the mass sum of SiO₂+Na₂O is preferably 33.0% or more, more preferably 35.0% or more, and still more preferably 38.0% or more.

On the other hand, if the mass sum of SiO₂+Na₂O is set to 65.0% or less, it is possible to suppress a decrease of the refractive index. Thus, an upper limit of the mass sum of SiO₂+Na₂O is preferably 65.0% or less, more preferably 60.0% or less, still more preferably 58.0% or less, and most preferably 55.0% or less.

[Manufacturing Method]

The chemically strengthened optical glass of the present disclosure may be manufactured as described below, for example. That is, raw materials such as oxides, carbonates, nitrates, and hydroxides are uniformly mixed so that the content of each component is within a predetermined content range. Next, the produced mixture is placed into a platinum crucible and melted in an electric furnace in a temperature range from 1200° C. to 1500° C. for one to four hours depending on the difficulty of melting the glass composition. Subsequently, the molten mixture is stirred and homogenized, and then, cooled to an appropriate temperature and casted into a mold. The mold is slowly cooled to manufacture the optical glass. Finally, the manufactured glass is chemically strengthened.

[Chemical Strengthening]

A method of chemically strengthening a glass is a method of strengthening a surface of the glass, which is called a chemical strengthening method, an ion exchange strengthening method, or the like. In the chemically strengthened optical glass according to the present disclosure, the surface of the glass is subjected to an ion exchange treatment to form a surface layer (compressive stress layer) in which compressive stress remains, and thus, the glass surface is strengthened. The ion exchange is generally performed at a temperature equal to or lower than the glass transition temperature. In the ion exchange, alkali metal ions having a small ionic radius (typically lithium ions and sodium ions) on the glass surface are substituted with alkali ions having a larger ionic radius (typically, sodium ions or potassium ions for lithium ions, and potassium ions for sodium ions). Thus, compressive stress remains on the surface of the glass, which improves the strength of the glass.

The chemical strengthening method may be implemented according to the following steps, for example. A glass base material is contacted to or immersed in a molten salt of a salt containing potassium or sodium, for example, potassium nitrate (KNO₃), sodium nitrate (NaNO₃) or a mixed salt or a complex salt thereof. The treatment of contacting or immersing the glass base material to or in the molten salt (chemical strengthening treatment) may be performed in one stage or in two stages.

For example, in the case of the two-stage chemical strengthening treatment, firstly, the glass base material is contacted to or immersed in a sodium salt or a mixed salt of potassium and sodium heated at 370° C. to 550° C. for 1 to 1440 minutes, preferably 90 to 800 minutes. Subsequently, secondly, the resultant glass base material is contacted to or immersed in a potassium salt or a mixed salt of potassium and sodium heated at 350° C. to 550° C. for 1 to 1440 minutes, preferably 60 to 800 minutes.

In the case of the one-stage chemical strengthening treatment, the glass base material is contacted to or immersed in a salt containing potassium or sodium or a mixed salt thereof heated at 370° C. to 550° C. for 1 to 1440 minutes, preferably 60 to 800 minutes.

The heat strengthening method is not particularly limited, but, for example, the glass base material may be heated to 300° C. to 600° C., and then, be subjected to rapid cooling such as water cooling and/or air cooling to form the compressive stress layer by a temperature difference between the surface and the inside of the glass substrate. When the heat strengthening method is combined with the above chemical treatment method, it is possible to more effectively form the compressive stress layer.

The ion implantation method is not particularly limited, but, for example, any type of ion may be caused to collide with the surface of the glass base material with an acceleration energy and an acceleration voltage that do not destroy the surface of the base material, to implant the ions into the surface of the base material. Thereafter, by performing heat treatment as necessary, it is possible to form the compressive stress layer on the surface in a similar manner as in the other methods.

[Refractive Index and Abbe Number]

The chemically strengthened optical glass of the present disclosure preferably has a high refractive index. In particular, a lower limit of the refractive index (nd) of the chemically strengthened optical glass of the present disclosure is preferably 1.65 or more, more preferably 1.67 or more, and still more preferably 1.68 or more.

On the other hand, an upper limit of the refractive index is preferably 1.85 or less, more preferably 1.83 or less, still more preferably 1.80 or less, and even more preferably 1.79 or less.

A lower limit of the Abbe number (νd) of the chemically strengthened optical glass of the present disclosure is preferably 20.0 or more, more preferably 22.0 or more, and still more preferably 23.0 or more. On the other hand, an upper limit of the Abbe number is preferably 33.0 or less, more preferably 30.0 or less, and still more preferably 28.0 or less.

The optical glass of the present disclosure preferably has less coloring, so that the transmittance for visible light is high, in particular, the transmittance for light on the short wavelength side of visible light.

In particular, an upper limit of the shortest wavelength Q) at which a sample of the optical glass of the present disclosure having a thickness of 10 mm exhibits a spectral transmittance of 5% is preferably 400 nm or less, more preferably 390 nm or less, and still more preferably 380 nm or less.

Thus, an absorption edge of the glass exists in the ultraviolet region or in the vicinity thereof, and the transparency of the glass with respect to visible light increases. Therefore, the optical glass can be preferably used for an optical element such as a lens that transmits light.

[Specific Gravity]

From the viewpoint of contributing to the weight reduction of optical elements and optical equipment, an upper limit of the specific gravity of the optical glass of the present disclosure is preferably 4.00 or less, more preferably 3.80 or less, still more preferably 3.50 or less, and even more preferably 3.30 or less.

On the other hand, in many cases, the specific gravity of the optical glass of the present disclosure is generally 2.00 or higher, more specifically 2.50 or higher, and still more specifically 3.00 or higher.

[Vickers Hardness]

The hardness of the chemically strengthened optical glass of the present disclosure is confirmed by the Vickers hardness (Hv). It is known that the Vickers hardness correlates with the scratch resistance, and thus, the scratch resistance of the present disclosure is expressed by the Vickers hardness (Hv). That is, if the Hv change rate represented by the following formula is set to 3.0% or more, it is possible to provide a chemically strengthened optical glass with improved crack resistance.

Hv change rate: [(Hv_{after}−Hv_{before})/Hv_{before}]×100

In the above formula, Hv_{after} is the Vickers hardness of the optical glass after chemical strengthening, and Hv_{before} is the Vickers hardness of the optical glass before chemical strengthening.

The Hv change rate of the chemically strengthened optical glass of the present disclosure expressed by the following formula may be 3.0% or more, preferably 5.0% or more, more preferably 7.0% or more, still more preferably 8.0% or more, even more preferably 9.0% or more, still even more preferably 10.0% or more, and further more preferably 11.0% or more. Thus, the chemically strengthened optical glass exhibits better crack resistance than the optical glass before the chemical strengthening.

### EXAMPLES

The following examples describe the present disclosure in detail for illustrative purposes. However, it should be noted that these examples are for illustrative purposes only and that various modifications may be made by those skilled in the art without departing from the gist and scope of the present disclosure.

In Examples (No. 1 to No. 29) and Comparative Example 1, glass of various compositions as listed in Tables 1 to 4 was manufactured. These glasses were obtained by the following procedure. High-purity raw materials used in ordinary chemically strengthened optical glass, including oxides, hydroxides, carbonates, nitrates, fluorides, and metaphosphate compounds, were selected as raw materials corresponding to raw materials of each composition. The raw materials were weighted and mixed to obtain a composition ratio of each of the Examples and the Comparative Example illustrated in Tables 1 to 4. Next, the mixed raw materials were transferred into a platinum crucible, melted in an electric furnace in a temperature range from 1200° C. to 1400° C. for one to four hours, depending on the difficulty of melting the glass composition, and the molten material was stirred and homogenized. Subsequently, the temperature was lowered to an appropriate temperature, the homogenized material was cast into a mold or the like and slowly cooled. Tables 1 to 4 show measurement results of the refractive index (nd) and the Abbe number (νd) for each of these glasses.

The refractive index (nd) and the Abbe number (νd) of the glass are indicated by measurement values for the d-line (587.56 nm) of a helium lamp according to the V-block method specified in JIS B 7071-2: 2018. The Abbe number (νd) is calculated by the formula Abbe number (νd)=[(nd−1)/(n_{F}−n_{C})], by using the refractive index for the d-line mentioned above, and values of the refractive index (n_{F}) for the F-line (486.13 nm) and the refractive index (n_{C}) for the C-line (656.27 nm) of a hydrogen lamp.

Here, the refractive index (nd) and the Abbe number (νd) were determined by measuring a glass obtained at a slow cooling rate of −25° C./hr.

Subsequently, the glass was immersed in potassium nitrate (KNO₃) as the potassium species (K bath) or sodium nitrate (NaNO₃) as the sodium species (Na bath) at the temperatures and during the time periods listed in Tables 1 to 4. Tables 1 to 4 show the results of calculating the Hv change rate for each of these glasses.

The transmittance of the glass was measured according to the Japan Optical Glass Industry Standard JOGIS 02-2019. In the present disclosure, the transmittance of the glass was measured to determine whether and to which degree the glass was colored. Specifically, a sample obtained by polishing opposing sides of the glass in parallel to a thickness of 10±0.1 mm was used to measure the spectral transmittance at 200 to 800 nm according to JIS Z 8722, to determine the wavelength (λ5) at which the spectral transmittance was 500.

A specific gravity ρ of the glasses in the Examples and the Comparative Example was measured based on the Japan Optical Glass Industry Standard JIS Z 8807: 2012 “Methods of measuring specific gravity of optical glass”.

The Vickers hardness of the glass was determined by pushing the glass using a 136 degrees pyramidal diamond indenter with a load of 980.7 mN for 10 seconds and dividing the load at which indentation was observed on the test surface by the surface area (mm²) calculated from the diagonal length of the depression of the indentation. The measurement was performed using a micro Vickers hardness tester HMV-G21D manufactured by Shimadzu Corporation.

TABLE 1

| | Example | | | | | | | |
|---|---|---|---|---|---|---|---|---|
| wt % | 1 | 2 | 3 | 4 | 5 | 6 | 7 | 8 |
| SiO₂ | 31.92 | 35.92 | 31.92 | 35.92 | 35.92 | 39.92 | 35.92 | 36.22 |
| B₂O₃ | | | | | | | | |
| Al₂O₃ | | | 4.00 | | 3.00 | | | |
| Y₂O₃ | | | | | | | | |
| La₂O₃ | | | | | | | | |
| TiO₂ | 28.91 | 28.91 | 28.91 | 28.91 | 25.91 | 28.91 | 28.91 | 29.14 |
| ZrO₂ | | | | 2.00 | | | | |
| Nb₂O₅ | 8.50 | 8.50 | 8.50 | 6.50 | 11.50 | 8.50 | 12.50 | 8.58 |
| WO₃ | | | | | | | | |
| BaO | 11.64 | 11.64 | 11.64 | 11.64 | 8.64 | 11.64 | 11.64 | 11.74 |
| Li₂O | | | | | | | | 0.77 |
| Na₂O | 14.00 | 13.00 | 10.00 | 10.00 | 10.00 | 6.00 | 6.00 | 8.48 |
| K₂O | 5.00 | 2.00 | 5.00 | 5.00 | 5.00 | 5.00 | 5.00 | 5.04 |
| Sb₂O₃ | 0.02 | 0.02 | 0.02 | 0.02 | 0.02 | 0.02 | 0.02 | 0.03 |
| TOTAL | 100.00 | 100.00 | 100.00 | 100.00 | 100.00 | 100.00 | 100.00 | 100.00 |
| refractive index (nd) | 1.7552 | 1.7665 | 1.7595 | 1.7605 | 1.7437 | 1.7596 | 1.7893 | 1.7701 |
| Abbe number (νd) | 27.30 | 26.40 | 26.10 | 26.80 | 26.83 | 26.10 | 24.80 | 26.25 |
| Transmittance (λ5) | 362 | 367 | 368 | 366 | 368 | 372 | 374 | 368 |
| Specific gravity(ρ) | 3.18 | 3.19 | 3.16 | 3.17 | 3.09 | 3.12 | 3.21 | 3.18 |
| Hv(before) | 594 | 642 | 637 | 657 | 647 | 647 | 654 | 640 |
| Hv(after) | 642 | 690 | 697 | 679 | 684 | 693 | 693 | 675 |
| Hv change rate(%) | 8.0 | 7.5 | 9.4 | 3.4 | 5.7 | 7.1 | 5.9 | 5.5 |
| Chemical strengthening | K bath | K bath | K bath | K bath | K bath | K bath | K bath | Na bath |
| conditons | 400° C. | 400° C. | 400° C. | 400° C. | 430° C. | 430° C. | 430° C. | 430° C. |
| | 24 h | 24 h | 24 h | 24 h | 6 h | 6 h | 6 h | 6 h → |
| | | | | | | | | K bath |
| | | | | | | | | 430° C. |
| | | | | | | | | 6 h |

TABLE 2

| | Example | | | | | | | |
|---|---|---|---|---|---|---|---|---|
| wt % | 9 | 10 | 11 | 12 | 13 | 14 | 15 | 16 |
| SiO₂ | 35.62 | 36.20 | 38.68 | 39.48 | 38.93 | 40.26 | 36.50 | 35.90 |
| B₂O₃ | | | | | | | | |
| Al₂O₃ | | | | | | | | |
| Y₂O₃ | | | | | | | | |
| La₂O₃ | | | | | | | | |
| TiO₂ | 28.67 | 29.13 | 30.17 | 26.56 | 26.19 | 29.15 | 29.37 | 28.89 |
| ZrO₂ | | 3.18 | 3.19 | 3.13 | 3.09 | | 3.21 | 3.16 |
| Nb₂O₅ | 8.44 | 8.57 | 5.13 | 8.41 | 11.62 | 8.57 | 8.64 | 8.50 |
| WO₃ | | | | | | | | |
| BaO | 11.54 | 7.77 | 11.73 | 11.52 | 9.43 | 11.74 | 7.83 | 7.70 |
| Li₂O | | | | | | | | |
| Na₂O | 8.34 | 10.08 | 6.05 | 5.94 | 5.85 | 7.66 | 11.78 | 8.41 |
| K₂O | 7.36 | 5.04 | 5.04 | 4.95 | 4.88 | 2.60 | 2.63 | 7.41 |
| Sb₂O₃ | 0.03 | 0.03 | 0.02 | 0.02 | 0.02 | 0.02 | 0.03 | 0.03 |
| TOTAL | 100.00 | 100.00 | 100.00 | 100.00 | 100.00 | 100.00 | 100.00 | 100.00 |
| refractive index(nd) | 1.7562 | 1.7674 | 1.7671 | 1.7566 | 1.7667 | 1.7644 | 1.7717 | 1.7614 |
| Abbe number(νd) | 26.81 | 25.91 | 25.88 | 26.58 | 25.74 | 25.78 | 25.80 | 26.28 |
| Transmittance(λ5) | 367 | 370 | 374 | 372 | 375 | 373 | 371 | 369 |
| Specific gravity(ρ) | 3.15 | 3.13 | 3.15 | 3.15 | 3.14 | 3.14 | 3.15 | 3.12 |
| Hv(before) | 637 | 647 | 648 | 642 | 640 | 642 | 654 | 642 |
| Hv(after) | 659 | 704 | 682 | 667 | 675 | 680 | 727 | 688 |
| Hv change rate(%) | 3.5 | 8.8 | 5.3 | 3.9 | 5.5 | 5.9 | 11.1 | 7.1 |
| Chemical strengthening | K bath | K bath | K bath | K bath | K bath | K bath | K bath | K bath |
| conditons | 430° C. | 400° C. | 400° C. | 400° C. | 400° C. | 400° C. | 400° C. | 400° C. |
| | 6 h | 6 h | 6 h | 6 h | 6 h | 6 h | 6 h | 6 h |

TABLE 3

| | Example | | | | | | | |
|---|---|---|---|---|---|---|---|---|
| wt % | 17 | 18 | 19 | 20 | 21 | 22 | 23 | 24 |
| SiO₂ | 28.92 | 35.92 | 42.87 | 36.83 | 23.92 | 45.87 | 29.92 | 31.92 |
| B₂O₃ | | | | | | | | |
| Al₂O₃ | | 3.00 | | | 4.00 | | | |
| Y₂O₃ | | | | | | | | |
| La₂O₃ | | | | | | | | |
| TiO₂ | 34.91 | 17.91 | 21.88 | 29.64 | 27.91 | 21.88 | 39.91 | 28.91 |
| ZrO₂ | | 3.00 | | 3.24 | | | | |
| Nb₂O₅ | 8.50 | 13.50 | 8.49 | 8.72 | 13.50 | 7.49 | 8.50 | 8.50 |
| WO₃ | | | | | | | | |
| BaO | 11.64 | 11.64 | 11.63 | 7.90 | 11.64 | 11.33 | 8.64 | 9.64 |
| Li₂O | | | | | | | | |
| Na₂O | 11.00 | 10.00 | 9.99 | 13.63 | 14.00 | 8.99 | 10.00 | 17.00 |
| K₂O | 5.00 | 5.00 | 5.00 | | 5.00 | 4.00 | 3.00 | 4.00 |
| Sb₂O₃ | 0.02 | 0.02 | 0.15 | 0.03 | 0.02 | 0.45 | 0.02 | 0.02 |
| TOTAL | 100.00 | 100.00 | 100.00 | 100.00 | 100.00 | 100.00 | 100.00 | 100.00 |
| Refractive index(nd) | 1.8119 | 1.7175 | 1.7030 | 1.7775 | 1.7761 | 1.6971 | 1.7462 | 1.7451 |
| Abbe number(νd) | 24.00 | 30.04 | 30.70 | 25.52 | 25.93 | 30.79 | 27.64 | |
| Transmittance(λ5) | 371 | 361 | 364 | 372 | 370 | 370 | 363 | 363 |
| Specific gravity(ρ) | 3.26 | 3.17 | 3.07 | 3.16 | 3.25 | 3.03 | 3.14 | 3.13 |
| Hv(before) | 623 | 635 | 637 | 658 | 603 | 612 | 567 | 569 |
| Hv(after) | 667 | 704 | 685 | 690 | 672 | 662 | 608 | 601 |
| Hv change rate(%) | 7.0 | 10.9 | 7.5 | 5.0 | 11.5 | 8.1 | 7.1 | 5.5 |
| Chemical strengthening | K bath | K bath | K bath | K bath | K bath | K bath | K bath | K bath |
| conditons | 400° C. | 400° C. | 400° C. | 400° C. | 400° C. | 400° C. | 400° C. | 400° C. |
| | 7 h | 7 h | 7 h | 6 h | 6 h | 6 h | 6 h | 6 h |

TABLE 4

| | | | | | | Comparative |
|---|---|---|---|---|---|---|
| | Example | | | | | Example |
| wt % | 25 | 26 | 27 | 28 | 29 | 1 |
| SiO₂ | 35.92 | 36.90 | 33.92 | 32.83 | 26.92 | 0.96 |
| B₂O₃ | | | | | | 0.49 |
| Al₂O₃ | | | | | | |
| Y₂O₃ | | | | | | |
| La₂O₃ | | | | | | |
| TiO₂ | 26.91 | 28.89 | 30.91 | 31.64 | 34.91 | 12.82 |
| ZrO₂ | | 3.16 | | 1.24 | 2.00 | |
| Nb₂O₅ | 17.50 | 9.21 | 12.50 | 10.72 | 10.50 | 47.37 |
| WO₃ | | | | | | |
| MgO | | 3.00 | | | | |
| CaO | | 1.00 | | | | |
| BaO | 7.64 | | 12.64 | 11.90 | 11.64 | 3.81 |
| Li₂O | | | | | | |
| Na₂O | 7.00 | 10.41 | 6.02 | 11.63 | 9.00 | 9.86 |
| K₂O | 5.00 | 7.41 | 4.00 | | 4.50 | |
| P₂O₅ | | | | | | 24.67 |
| Sb₂O₃ | 0.02 | 0.03 | | 0.03 | 0.52 | 0.03 |
| TOTAL | 100.00 | 100.00 | 100.00 | 100.00 | 100.00 | 100.00 |
| Refractive index(nd) | 1.7920 | 1.7470 | 1.8123 | 1.8156 | 1.8469 | 1.9229 |
| Abbe number(νd) | 24.33 | 26.68 | 23.74 | 23.97 | 22.70 | 18.90 |
| Transmittance(λ5) | 374 | 368 | 377 | 376 | 396 | 390 |
| Specific gravity(ρ) | 3.18 | 2.98 | 3.27 | 3.29 | 3.34 | 3.58 |
| Hv(before) | 614 | 635 | 628 | 640 | 621 | 544 |
| Hv(after) | 664 | 693 | 669 | 677 | 669 | 548 |
| Hv change rate(%) | 8.1 | 9.1 | 6.6 | 5.9 | 7.8 | 0.7 |
| Chemical strengthening | K bath | K bath | K bath | K bath | K bath | K bath |
| conditons | 400° C. | 400° C. | 400° C. | 400° C. | 420° C. | 400° C. |
| | 6 h | 6 h | 6 h | 6 h | 4 h | 6 h |

The results indicated that the chemically strengthened optical glass of the Examples of the present disclosure has a high refractive index and the Hv change rate, which is defined as [(Hv_{after}−Hv_{before})/Hv_{before}]×100, being equal to or greater than 3.0%.

1. A chemically strengthened optical glass comprising a compressive stress layer on a surface,
the chemically strengthened optical glass comprising, by mass % in terms of oxide:
20.0% to 50.0% of a SiO₂ component;
10.0% to 45.0% of a TiO₂ component; and
0.1 to 20.0% of a Na₂O component, wherein
an Hv change rate defined as [(Hv_{after}−Hv_{before})/Hv_{before}]×100 is equal to or greater than 3.0%.

2. The chemically strengthened optical glass according to claim 1, further comprising 3.0 to 20.0% of a Nb₂O₅ component by mass % in terms of oxide.

3. The chemically strengthened optical glass according to claim 1, further comprising, by mass % in terms of oxide:
0 to 15.0% of Al₂O₃;
0 to 15.0% of ZrO₂;
0 to 20.0% of BaO;
0 to 10.0% of Li₂O;
0 to 15.0% of K₂O; and
0 to 1.0% of Sb₂O₃.

4. The chemically strengthened optical glass according to claim 1, wherein a refractive index (nd) is from 1.65 to 1.85 and an Abbe number (νd) is from 20.0 to 33.0.

5. The chemically strengthened optical glass according to claim 2, further comprising, by mass % in terms of oxide:
0 to 15.0% of Al₂O₃;
0 to 15.0% of ZrO₂;
0 to 20.0% of BaO;
0 to 10.0% of Li₂O;
0 to 15.0% of K₂O; and
0 to 1.0% of Sb₂O₃.

6. The chemically strengthened optical glass according to claim 2, wherein a refractive index (nd) is from 1.65 to 1.85 and an Abbe number (νd) is from 20.0 to 33.0.

7. The chemically strengthened optical glass according to claim 3, wherein a refractive index (nd) is from 1.65 to 1.85 and an Abbe number (νd) is from 20.0 to 33.0.
